(19) United States
(12) Patent Application Publication
(10) Pub. No.: US 2014/0200859 A1
(43) Pub. Date: Jul. 17, 2014

(54) MULTI-STANDARD SITE CONFIGURATION TOOL

(71) Applicant: TELEFONAKTIEBOLAGET L M ERICSSON (PUBL), Stockholm (SE)

(72) Inventor: Norbert Gershin, Ottawa (CA)

(73) Assignee: Telefonaktiebolaget L M Ericsson (Publ), Stockholm (SE)

(21) Appl. No.: 13/743,900

(22) Filed: Jan. 17, 2013

(51) Int. Cl. G06F 17/50

(52) U.S. Cl. CPC G06F 17/509
USPC 703/1

(57) ABSTRACT

A multi-standard configuration tool allows a user to configure multiple nodes located at a single network site implementing different radio access technologies. The multi-standard site configuration tool uses a data model to represent equipment and carriers at a network site. The configuration tool includes a configuration editor to create and modify a site configuration model, a configuration file generator to generate configuration files based on the site configuration model, and a configuration graphics generator to generate a graphical representation of the entire site configuration in real-time.

### TECHNICAL FIELD

The present invention relates generally to configuration tools for configuring equipment and carriers at a network site in a wireless communication network and, more particularly, a multi-standard configuration tool for configuring equipment and carriers for multiple nodes implementing different radio access located at a single network site.

### BACKGROUND

In a wireless communication system, a network site may comprise a plurality of co-located nodes. Each node comprises radio equipment for communicating with user equipment (UE) in a sector or cell served by the node, and digital processing circuitry for processing signals transmitted and received by the node. In some network sites, the different nodes may implement different radio access technologies (RATs). For example, a first node may be configured to use the Long Term Evolution (LTE) standard and a second node may be configured to use the Global System for Mobile Communications (GSM) standard or Wideband Code Division Multiple Access (WCDMA) standard.

During network planning, each node at a network site needs to be configured. An exemplary site equipment configuration may specify the following elements for each node:
radio units containing radio circuitry;
digital units containing digital processing circuits;
support system units such as batteries, power supplies, etc.;
antenna units;
auxiliary antenna units such as tower mounted amplifiers (TMAs) and remote electrical tilts (RETs);
sectors; and
RF branches.
   The carrier configuration also needs to be determined during network planning. The carrier configuration specifies the transmission and reception carrier branches and their groupings that are specific to the RAT used by the node. For example, in the case of LTE, the groupings comprise the carrier sectors (geographical sectors) and cells.

Network site and carrier configuration tools currently in use are standard specific. Therefore, in a network site using different RATS, the engineer is required to use different configuration tools to configure different nodes. For example, in a network site that mixes LTE and GSM nodes, the engineer needs one tool to configure the LTE nodes and another tool to configure the GSM nodes.

The need to use different configuration tools for nodes using different RATs presents a number of problems. None of the configuration tools allows the service technician to visualize the configuration for the entire site. The inability to visualize the configuration for the entire site may lead to configuration errors. For example, the engineer may inadvertently assign to a node using one RAT resources that were already allocated to another node using a different RAT. In the event that a configuration error is made, there is no capability for troubleshooting conflicts in configurations of nodes using different RATS.

### SUMMARY

The present invention provides a multi-standard configuration tool that allows a user to configure multiple nodes located at a single network site implementing different radio access technologies. The multi-standard site configuration tool uses a data model to represent equipment and carriers at a network site. The configuration tool includes a configuration editor to create and modify a site configuration model, a configuration file generator to generate configuration files based on the site configuration model, and a configuration graphics generator to generate a graphical representation of the entire site configuration in real-time.

Exemplary embodiments of the invention comprise a computer system for generating a site configuration for a network site in a mobile communication network. The computer system according to an exemplary embodiment comprises an editing circuit, a graphics generating circuit, and a file generating circuit. The editing circuit is configured to receive user input of configuration data. The editing circuit is further configured to generate, based on the configuration data, a mixed-mode site configuration model comprising a collection of data objects representing two or more nodes implementing different communication standards. The graphics generating circuit is configured to create an integrated digital graphical representation of the mixed mode site configuration model for display to a user on an electronic display device. The file generating circuit is configured to create digital configuration files for the nodes in the mixed mode site configuration model.

Other embodiments of the invention comprise methods implemented by a computer system of generating a site configuration for a network site in a mobile communication network. The computer system including an editing circuit, a graphics generating circuit, and a file generation circuit. In an exemplary embodiment of the method, the editing circuit receives user input of configuration data. Based on the user input, the editing circuit generates a mixed-mode site configuration model comprising a collection of data objects representing two or more nodes implementing different communication standards. The graphics generating circuit creates an integrated digital graphical representation of the mixed mode site configuration model for display to a user on an electronic display device. The file generating circuit creates digital configuration files for the nodes in the mixed mode site configuration model.

### BRIEF DESCRIPTION OF THE DRAWINGS

FIG. 1 illustrates the main functional elements of a site configuration tool according to an exemplary embodiment.

FIG. 2 illustrates a computer system configured according to an exemplary embodiment.

FIG. 3 illustrates an exemplary data model used by the site configuration tool.

FIG. 4 is a graphical representation of a first site configuration generated by the site configuration tool.

FIG. 5 illustrates an exemplary site configuration model created with the site configuration tool.

FIG. 6 illustrates a configuration editor in the configuration tool.

FIG. 7 illustrates real-time graphics generation by the site configuration tool.

FIG. 8 illustrates an exemplary method implemented by a computer system of creating a site configuration.

FIG. 9 illustrates the main panel displayed by the configuration editor in one exemplary embodiment.

FIG. 10 illustrates the common support system panel displayed by the configuration editor in one exemplary embodiment.

FIG. 11 illustrates the sector panel displayed by the configuration editor in one exemplary embodiment.

FIG. 12 illustrates the sector panel displayed by the configuration editor in one exemplary embodiment.

FIG. 13 illustrates the common antenna system panel displayed by the configuration editor in one exemplary embodiment.

FIG. 14 is a graphical representation of a second site configuration generated by the site configuration tool.

FIG. 15 is a graphical representation of a third site configuration including auxiliary antenna equipment generated by the site configuration tool.

FIG. 16 is a graphical representation of a fourth site configuration generated by the site configuration tool including carrier configuration information.

FIG. 17 illustrates an exemplary process for creating a site configuration using the site configuration tool.

### DETAILED DESCRIPTION

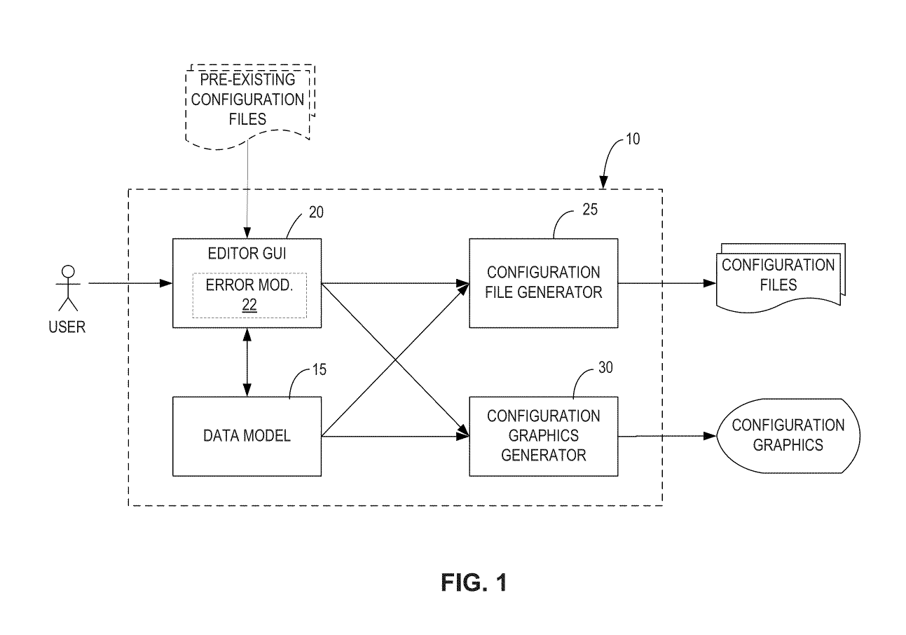

Referring now to the drawings, FIG. 1 illustrates the main functional elements of a multi-standard site configuration tool 10 according to an exemplary embodiment. The configuration tool 10 is used to configure a network site having equipment for multiple nodes (e.g. access nodes) operating according to two or more different RATs, which is referred to herein as a mixed mode network site. For example, a mixed mode network site may have equipment for one node operating according to the LTE standard and another node operating according to the GSM standard. In other embodiments, the mixed mode network site may have equipment for one node operating according to the LTE standard and another node operating according to the WCDMA standard.

The main elements of the site configuration tool 10 comprise a data model 15, configuration editor 20, configuration file generator 25, and configuration graphics generator 30. The data model 15 comprises a set of classes that describe the properties and behaviors of all elements in a site configuration. The configuration editor 20 comprises the business logic and graphical user interface (GUI) elements that enable the user to create and edit site configurations. The configuration file generator (CFG) 25 is used to produce the configuration files for each node. The configuration graphics generator (CGG) 30 is used to create and display a graphical representation of the entire site configuration. In some embodiments, the configuration editor 20 may be configured to load a pre-existing configuration file for editing and include an optional error module 22 for detecting semantic and syntactical errors in the pre-existing configuration file.

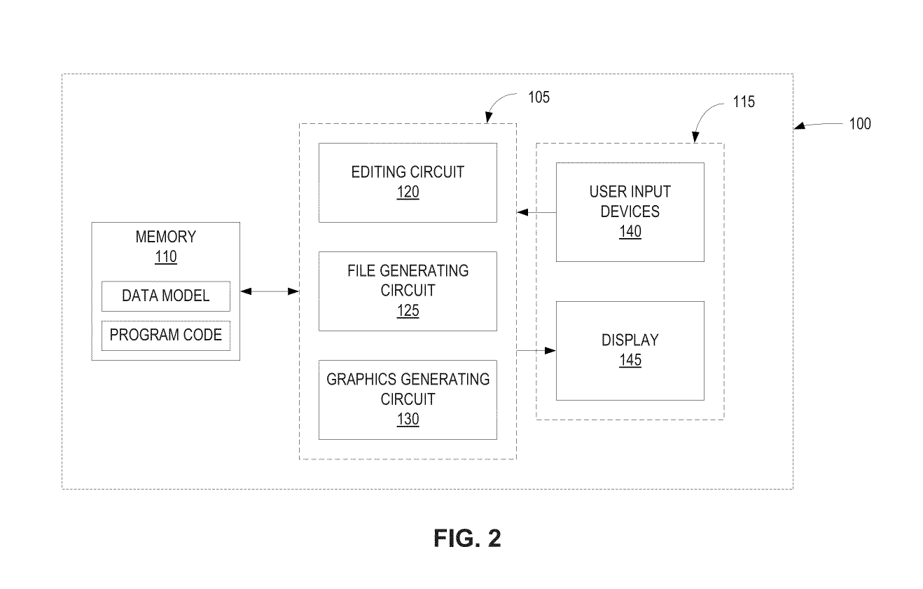

FIG. 2 illustrates a computer system 100 for implementing the configuration tool 10 in one exemplary embodiment. The computer system 100 comprises processing circuits 105, memory 110, and a user interface 115.

The processing circuits 105 may comprise one or more processors, hardware, firmware or a combination thereof. The processing circuits 105 include an editing circuit 120, a file generation circuit 125, and a graphics generating circuit 130. The editing circuit 120 comprises a processor and/or other circuits dedicated to performing the functions of the configuration editor 20. The file generation circuit 125 comprises a processor and/or other circuits dedicated to performing the functions of the file generator 25. The graphics generation circuit 130 comprises a processor and/or other circuits dedicated to performing the functions of the configuration graphics generator 30. In one exemplary embodiment, the editing circuit 120, the file generation circuit 125, and the graphics generating circuit 130 are implemented by a single processor that is programmed to perform the functions of the configuration editor 20, configuration file generator 25, and configuration graphics generator 30.

Memory 110 comprises both volatile and non-volatile memory for storing programs and data needed for operation as herein described. Memory 110 stores the data model 15 used by the configuration tool 10, as well as program code to implement the functions of the configuration editor 20, configuration file generator 25, and configuration graphics generator 30. The memory 110 may be integrated with the processing circuit 105 or may comprise discrete memory device. The memory 110 may include random access memory (RAM), read only memory (ROM), Flash memory, optical memory, magnetic memory, or other known memory devices.

The user interface 115 enables a user to interact with the computer system 100 to create a site configuration. The user interface 115 comprises one or more user input devices 140 and a display device 145. The user input devices 140 may comprise any computer input device for inputting data and commands, such a mouse, keyboard, touchpad, touchscreen, trackball, etc. Multiple user input devices 140 may be used to input data. The display device 145 may comprise a liquid crystal display (LCD) or touch screen display, which may also serve as a user input device 140.

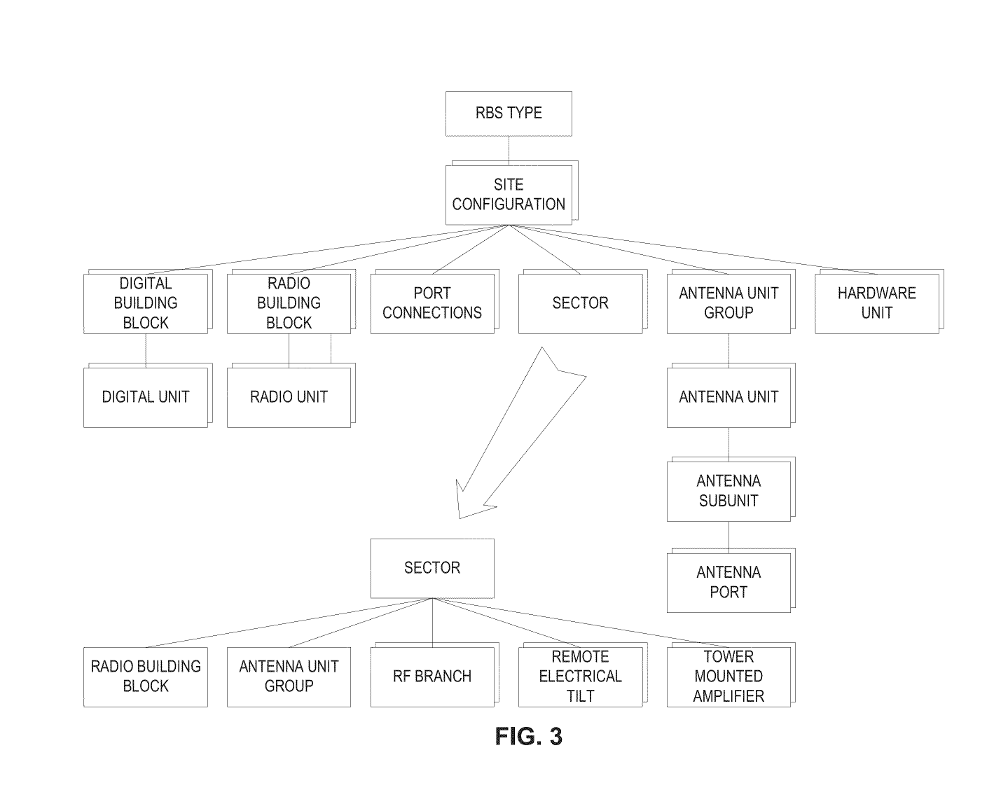

FIG. 3 illustrates an exemplary data model according to one exemplary embodiment for representing a site configuration. The data model comprises a set of data objects that represent the elements in a site configuration. Each object is defined by a set of attributes that describe the properties and behaviors of the object. Examples of objects include Digital Building Blocks (DBBs), Radio Building Blocks (RBBs), and Antenna Sub-units (ASUs). A DBB may comprise one or more Digital Units (DUs). A RBB may comprise one or more Radio Units (RUs). Each object has a set of attributes that describe the properties and behavior of the data object. The attributes include:
Generic object attributes—attributes that describe properties and behaviors that are possessed by all objects within a class. For example, the Radio Building Block (RBB) object will include attributes that describe a generic RBB. A generic object attribute applies to all objects within the class. An example of a generic object attribute is the RAT attribute for a RBB that indicates the radio access technology.
Type-specific object attributes—attributes that describe properties and behaviors that are specific to a particular type of object within a class. There may be different types of RBBs that have type-specific attributes. A type-specific attribute may be present in some but not all objects within a class.
   Table 1 below lists the data objects available in one exemplary data model.

| Object Type | Description |
|---|---|
| RBS Type | The base-station type, associated with the cabinet. |
| | Examples: RBS6101, RBS6601. |
| Site Configuration | The collection of objects comprising all the configuration |
| | data for a site. |
| | Examples: LTE 1-3 Sector Star Configuration, Multi- |
| | Standard Mixed Mode Basic GSM-LTE |
| Digital Building Block | A set of Digital Units serving a Site. |
| Digital Unit | A device that provides switching, traffic management. |
| | timing, baseband processing, and a radio interface. |
| Radio Building Block | A set of Radio Unit serving one or several Sectors. The |
| | Radio Units may be cascaded. |
| Radio Unit | A device that provides radio services to one or several |
| | Sectors. Can be a remote Radio Unit or Antenna- |
| | integrated Radio Unit. |
| Port Connections | A collection of objects describing the connections |
| | between other objects representing devices: Digital |
| | Units, Radio Units, Antenna Units, Remote Electrical Tilts |
| | and Tower Mounted Amplifiers. |
| Sector | Abstraction of a geographical area covered by an |
| | Antenna Unit Group. |
| Antenna Unit Group | Collection several Antenna Units serving a Sector. |
| Antenna Unit | Contains several Antenna Subunits installed with a |
| | common mechanical tilt. |
| Antenna Subunit | Contains all Antenna elements with the same tilt angle. |
| Antenna Port | Antenna feeder port on the Antenna Unit where the |
| | Antenna branch is connected. |
| Hardware Unit | Common Supporting System device like Power Supply |
| | Unit, Power Distribution Unit, Battery Fuse Unit, etc. |
| RF Branch | Connection from an Antenna feeder port on the RU to |
| | one Antenna feeder connector on one or several |
| | Antenna Units. |
| Remote Electrical Tilt | Devices that provides for remote electrical tilting of the |
| | Antenna Unit where it is mounted. |
| Tower Mounted Amplifier | Device that provides low noise amplification of the uplink |
| | received by the reserving branch. |

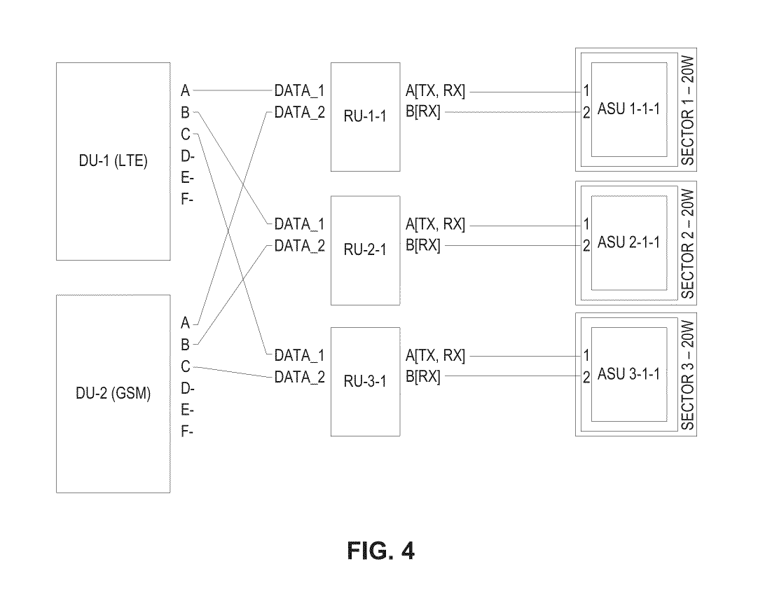

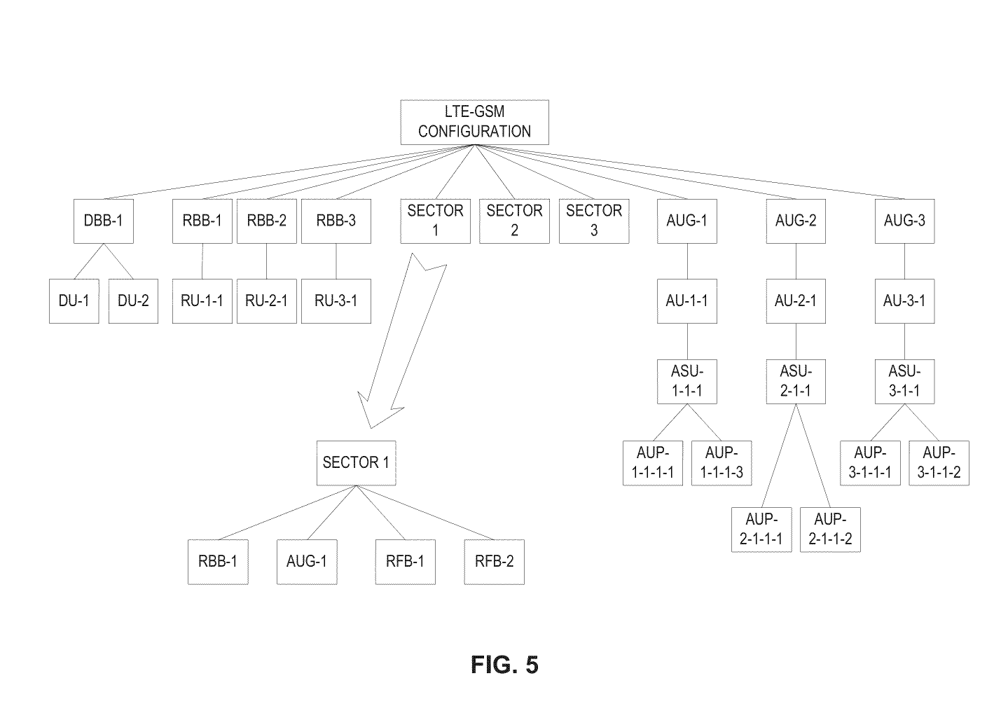

A site configuration is created by instantiating objects and specifying the relationship between the objects FIG. 4 illustrates an exemplary site configuration for a 3-sector, mixed mode network site including equipment for an LTE node and GSM node as generated by the tool 10 in a graphical manner. The equipment comprises two DUs (one for each node), three RUs (one for each sector), and three ASUs (one for each sector). The DUs include data ports that are connected to corresponding data ports on the RUs. The RUs also include radio ports that connect to corresponding radio ports on the ASUs. FIG. 5 illustrates the site configuration model based on the site configuration shown in FIG. 4 and the data model shown in FIG. 3. The site configuration model in FIG. 5 shows the data objects created for the site configuration illustrated in FIG. 4. For example, the site configuration model include two concrete instances of the DU object (denoted DU-1 and DU-2) and three concrete instances of the RU object (denoted RU-1-1, RU-2-1 and RU-3-1). The port connections representing the connections between the DUs and RUs were omitted from FIG. 5 for the sake of simplicity.

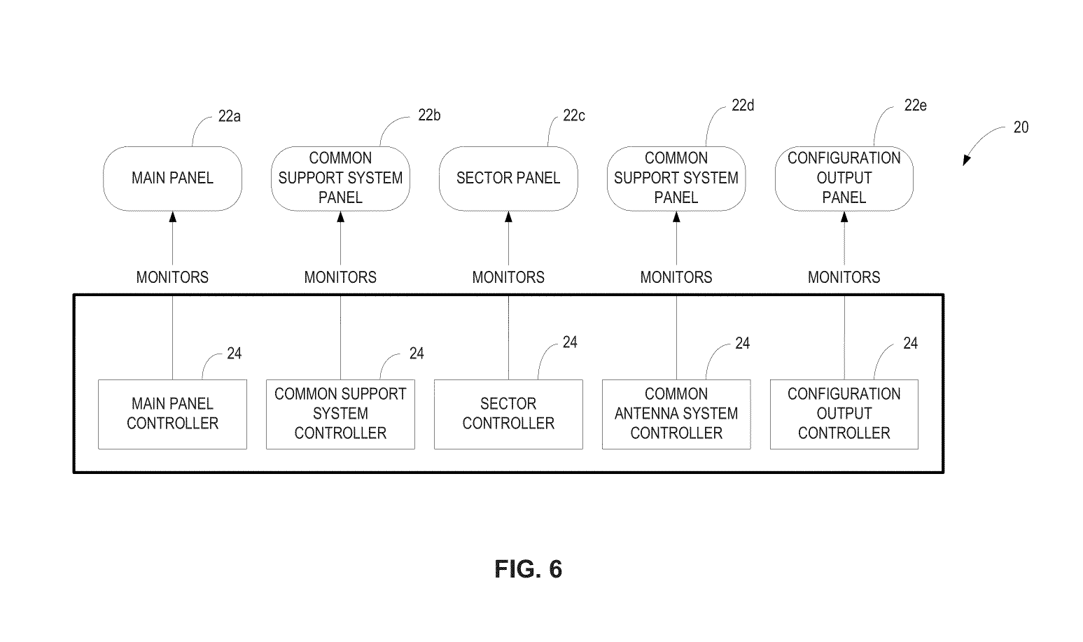

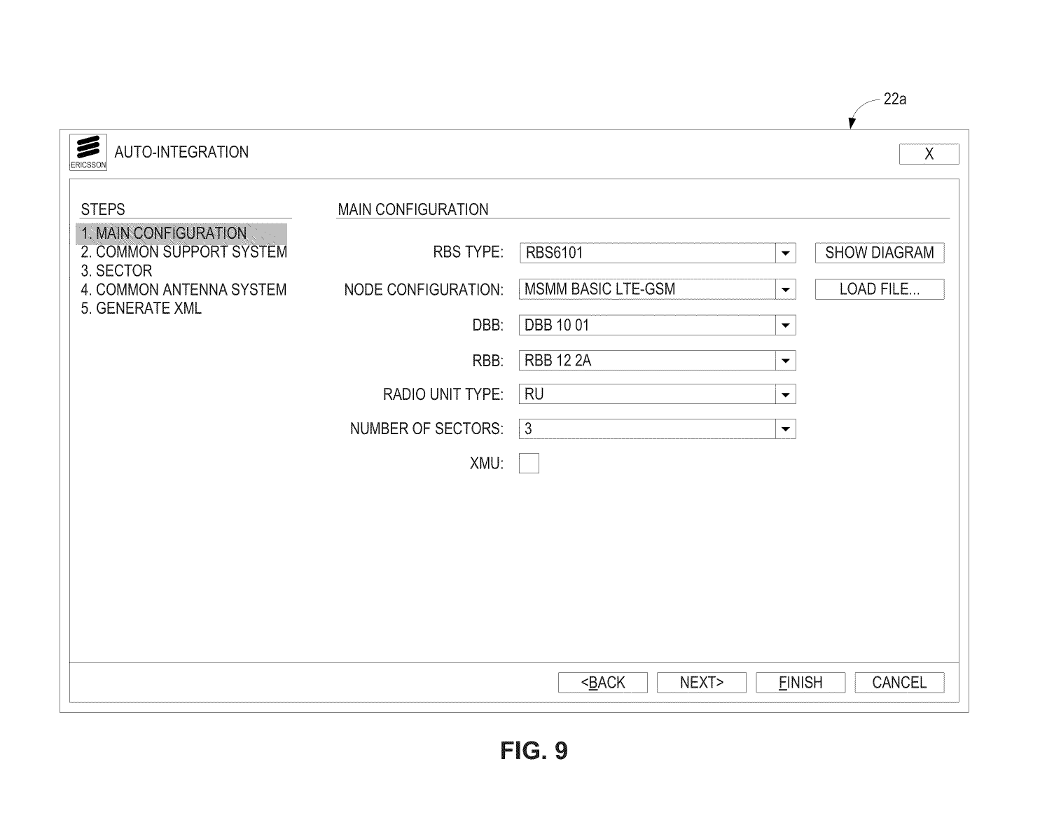

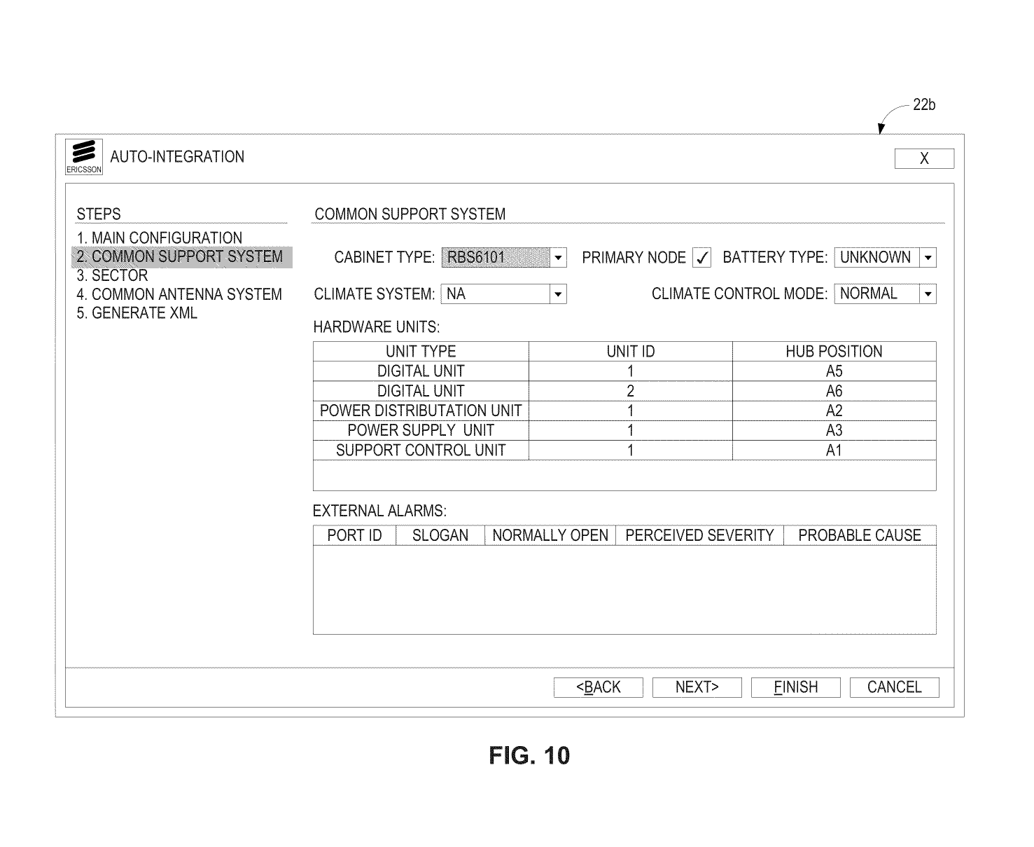

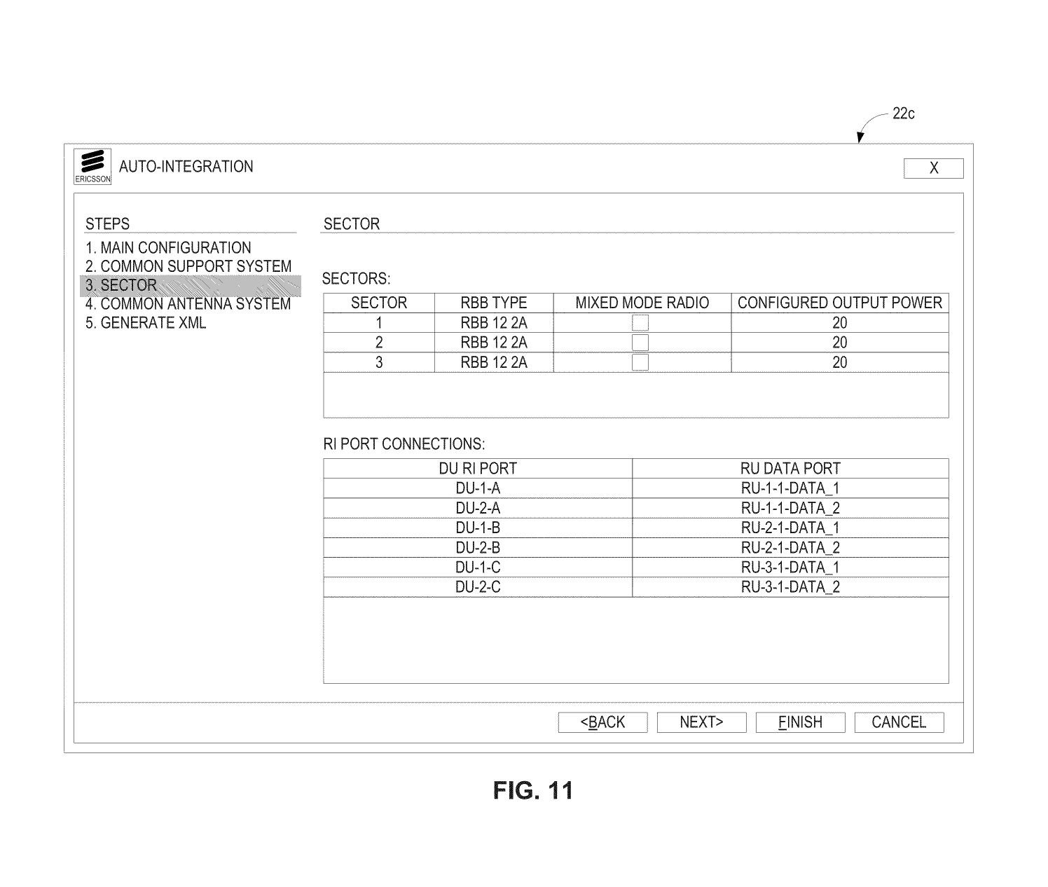

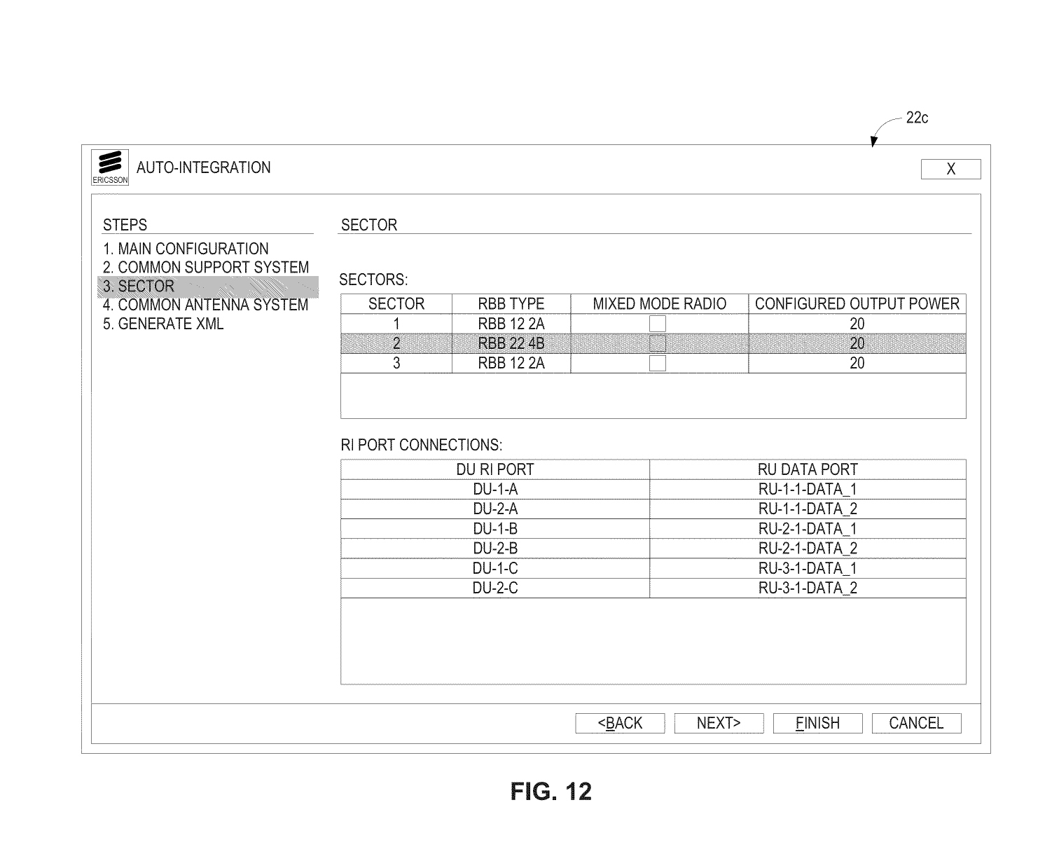

The configuration editor 20 presents a graphical user interface (GUI) to the user for creating and editing a site configuration. Referring to FIG. 6, the configuration editor 20 according to one embodiment groups the configuration settings that can be modified by a user and presents in the configuration settings in a series of configuration panels 22. In the embodiments shown in FIG. 6, there are five configuration panels 22: the main panel 22a (FIG. 9), the common support system panel 22b (FIG. 10), the sector panel 22c (FIG. 11), the common support system panel 22d (FIG. 12), and the configuration output panel 22e. The configuration editor 20 includes a controller 24 for each configuration panel. Each controller 24 is responsible for:
initializing the field controls of the associated panel,
populating the field controls based on appropriate current configuration parameters,
handling user-initiated configuration changes,
notifying the CGG 30 when the site configuration is modified; and
transitioning between panels 22.

The configuration file generator (CFG) 25 is responsible for creating a configuration file from a site configuration model. Given a site configuration model, the CFG 25 produces one site equipment configuration file for each node present in the site configuration. The CFG 25 first identifies the DUs in the site configuration model, each of which represents a node. Each DU in the site configuration model has an attribute indicating the RAT it supports, which allows the CFG 25 to determine the content required for the configuration file. Beginning with a given DU, the CFG 25 follows the port connections to the RUs, sectors and antenna unit groups to collect the data for the configuration file. The collected data is formatted into an XML document or other formatted document.

The configuration graphics generator (CGG) 30 takes a site configuration model as input and produces a digital graphical representation of the site configuration for printing or display to the user on a display device. In general, a site configuration model includes a concrete set of instantiated objects and port connections between the objects. The CGG 30 uses the object attributes to create a graphical representation of the object. As an example, for a given instance of an RBB, the CGG determines the number of data ports, RF ports, and input/output (I/O) ports and creates a representation of the RBB object. The uses the information about port connections to draw connecting lines between the represented objects.

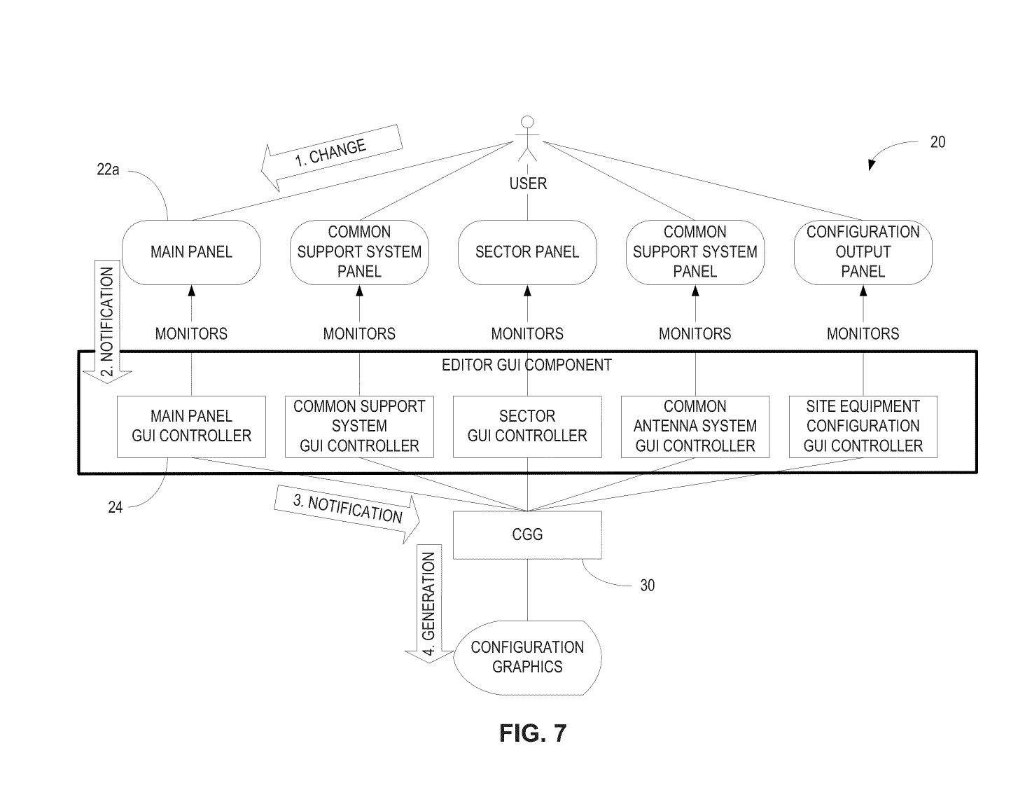

In one exemplary embodiment, the CGG 30 updates the graphical representation of the site configuration in real time as the user makes changes to the site configuration. The process for updating the graphical representation of the site configuration is shown in FIG. 7. As shown in FIG. 7, the user can make changes through one of the configuration panels 22. When the user makes a change, the configuration panel 22 notifies the corresponding controller, which in turn notifies the CGG 30. The CGG 30 then updates the graphical representation of the site configuration in real time as the changes are made.

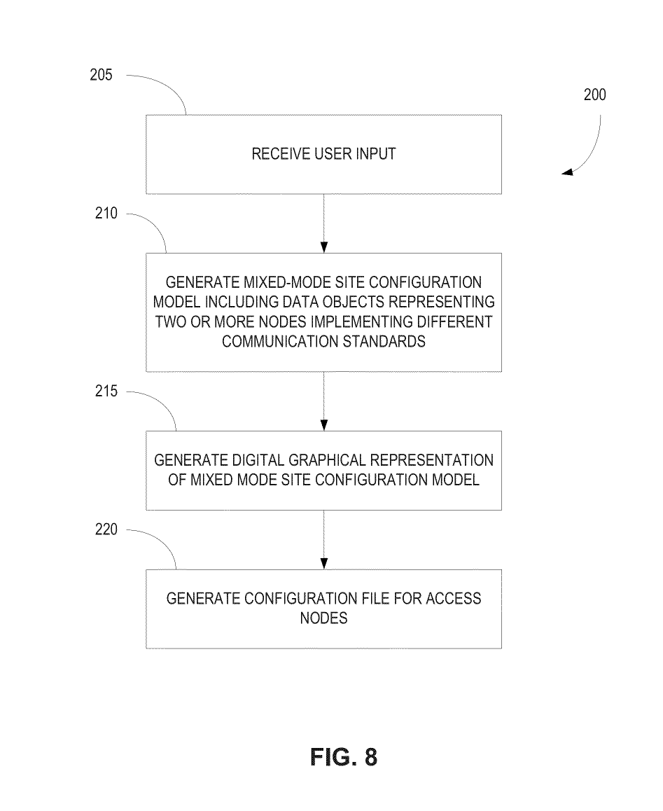

FIG. 8 illustrates a method 200 implemented by the computer system 100 shown in FIG. 2 of creating a site configuration for a mixed mode network site. The editing circuit 120 receives user input of configuration data (block 205). Based on the user input, the editing circuit 120 generates a mixed-mode site configuration model comprising a collection of data objects representing elements in the site configuration (block 210). The site configuration model includes data objects representing two or more nodes implementing different communication standards. The graphics generating circuit 130 generates an integrated digital graphical representation of the mixed mode site configuration model for display to a user on an electronic display device (block 215). The file generating circuit 125 creates or generates a digital configuration file for the two or more nodes from the mixed mode site configuration model (block 220). The file generating circuit 125 may generate a separate configuration file for each node, or may create a single configuration file for two or more nodes.

The following describes in more detail how a site configuration is generated in one exemplary embodiment. When the configuration editor 20 is launched, the main configuration panel 22a is shown. FIG. 9 illustrates the main panel 22a that is presented to the user on the display device 145. In one exemplary embodiment, the configuration editor 20 may load a default site configuration template when it is launched. In this case, default values may be displayed in the control fields on the main panel 22a when the configuration editor 20 is launched. The user can then change the values displayed in the control fields if a different configuration is desired. The user may also select a pre-existing configuration file to be loaded by the configuration editor 20.

To begin the site equipment configuration, the user updates the settings in the main panel 22a according to the desired site configuration. The settings are selected in the order presented beginning with the RBS type and continuing with the node configuration, DBB type, RBB type, and so on. The order of presentation is based on the data model. Configuration settings can be entered by selecting an appropriate value from a drop-down list, by entering a value into a text box, by selecting a check box, or by selecting a radio button. Other form controls may also be used to get input of configuration data from the user. The configuration editor 20 may apply business rules to enforce consistency in the configuration settings entered by the user. In some embodiments, the configuration editor 20 may be programmed to limit the available values for lower order settings to values that are compatible with the values entered for the higher order settings. For example, the possible values for the node configuration setting can be limited by the RBS type. Similarly, the possible values for the DBB may be limited by the RBS type and node configuration. Also, when a higher order setting is modified, a lower order setting may be changed automatically to a default value if the lower order setting is no longer compatible with the higher order setting. Thus, if the node configuration is changed, the configuration editor 20 may automatically change the DBB and/or RBB to default values compatible with the modified node configuration if the current DBB and RBB are not compatible. Using predefined business rules to enforce consistency simplifies the creation of a site configuration and avoids consistency errors.

In FIG. 9, the node configuration is set to multi-standard mixed mode (MSMM) Basic LTE-GSM. The DBB, RBB, and RU type are automatically filled with default values based on the node configuration. The number of sectors is set to 3. This node configuration is shown graphically in FIG. 4.

After the settings on the main panel 22a are selected, the user goes to the common support system panel 22b shown in FIG. 10. The common support system panel 22b is used to specify support equipment which may be shared by multiple nodes. Common support equipment includes battery fuse units, power distribution units, power supply units, support alarm units, and support control units. Common support equipment is represented in the data model as hardware units. Default hardware units may be selected automatically by the configuration tool 10 based on the selected DUs and RUs. The user can change the default hardware units, or add additional hardware units.

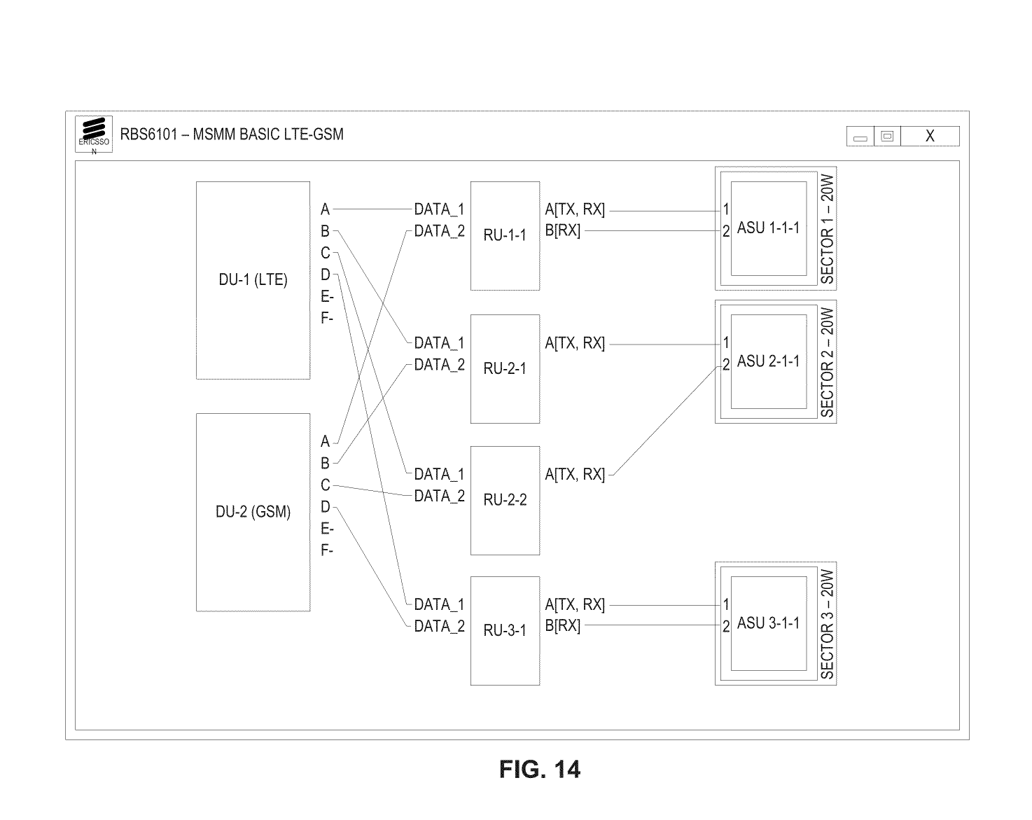

When the common support systems are specified, the user goes to the sector configuration panel 22c shown in FIG. 11. The sector configuration panel 22c allows the user to review the sector settings and make specific changes as needed or desired. Initially, the RBB instances are set according to the default type configured in the main panel. Custom RBB types can be specified in the sector configuration panel. In FIG. 12, the RBB type for sector 2 has been changed to RBB 22 4B. FIG. 14 shows a graphical representation of this updated site configuration.

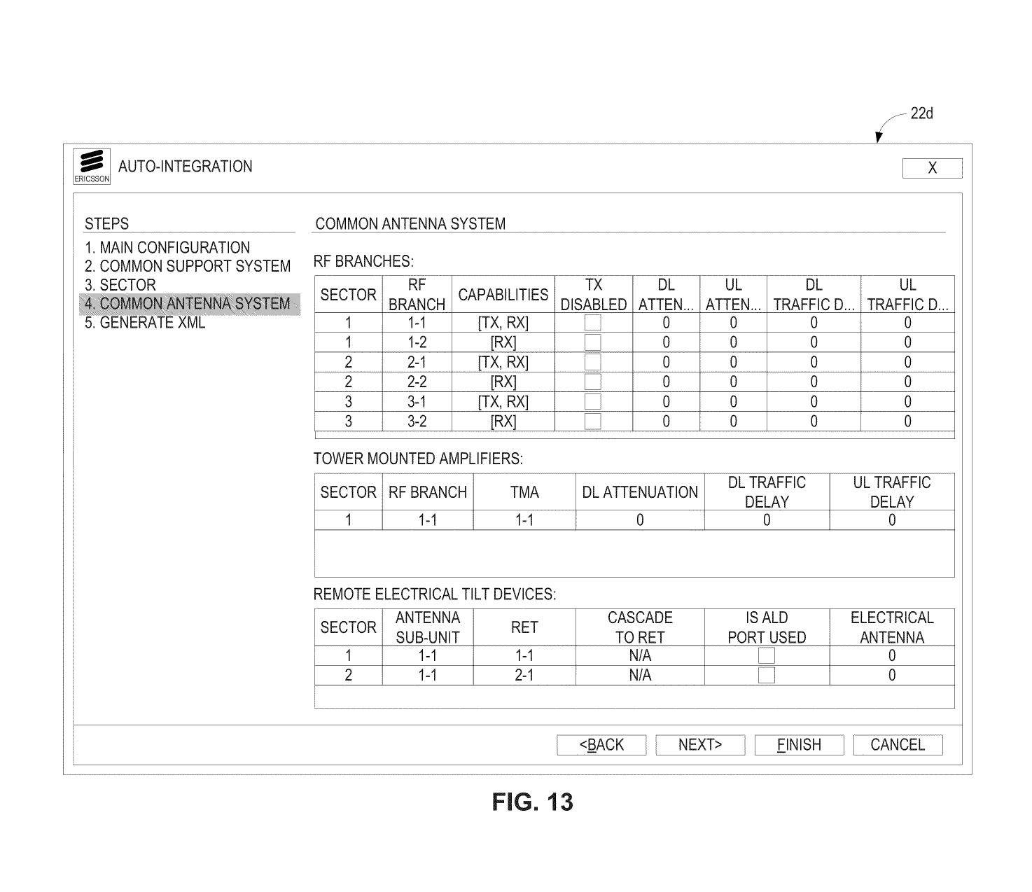

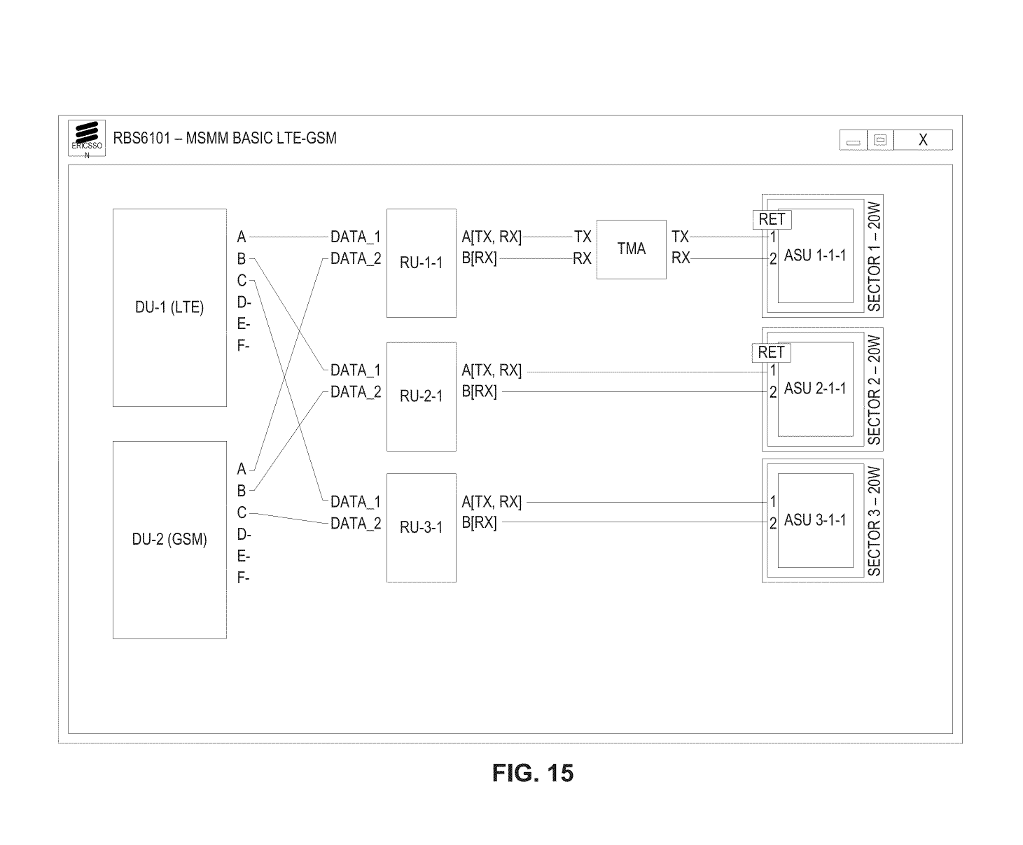

When the sector configuration is complete, the user moves to the common antenna system panel 22d as shown in FIG. 13. This panel allows the user to customize the configurations for RF branches and to configure auxiliary equipment such as tower mounted amplifiers (TMAs) and remote electric tilts (RETs). In this example, a TMA is specified for sector 1 and a RET is specified for sectors 1 and 2. FIG. 15 shows the updated site configuration reflecting the specified antenna system components.

At this point, the site configuration is complete. The user can move to the configuration output panel 22e to generate the configuration file for the site configuration. The configuration output panel displays a XML document that is generated based on the site configuration. An exemplary XML document for the site configuration shown in FIG. 3 is attached hereto as Appendix A.

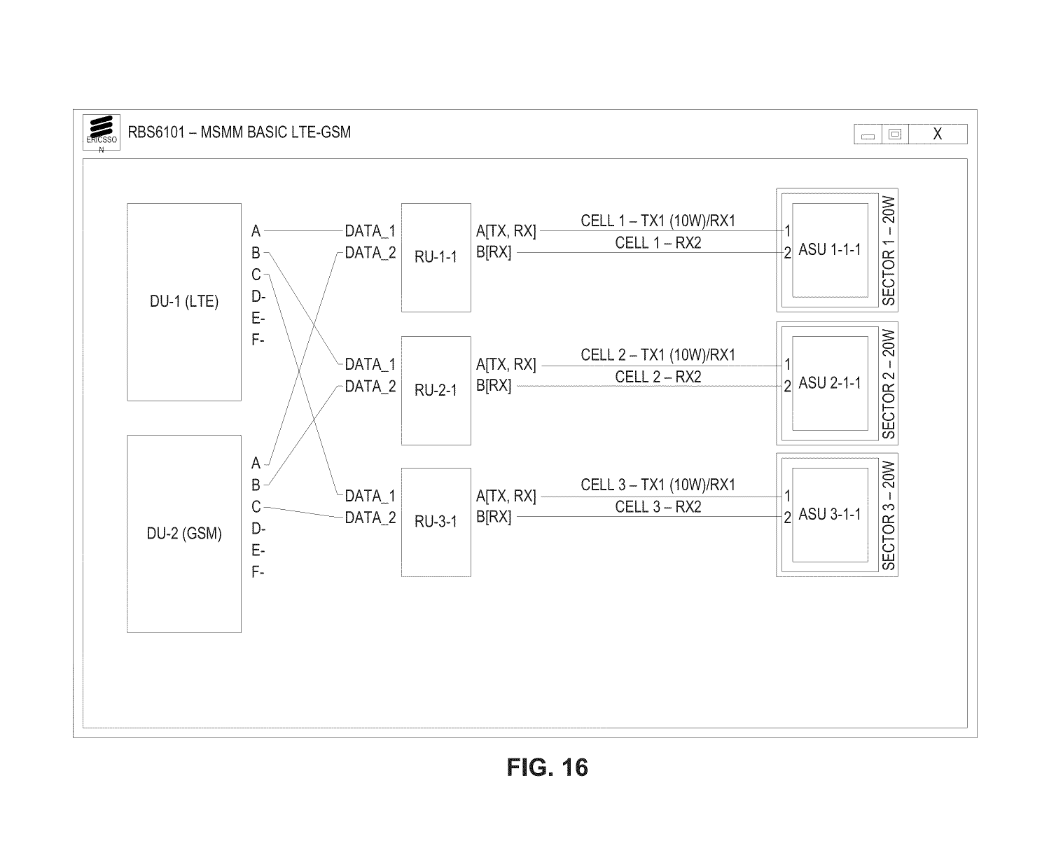

In some embodiments, the configuration tool 10 may be used to specify a carrier configuration in addition to the site equipment configuration. The carrier configuration specifies how the equipment resources are used to transmit and receive carriers. The carrier configuration may be handled in the same way as the equipment configuration. The data model may be extended to include carrier entities. An additional configuration panel 22 may be included in the configuration editor 20 to enable the user to create and change the carrier configuration. The CFG and CGG may also be extended to handle the new carrier entities. FIG. 16 illustrates an exemplary site configuration including a carrier configuration. As shown in FIG. 16, the radio units (RUs) are configured to transmit and receive on port A and to receive only on port B.

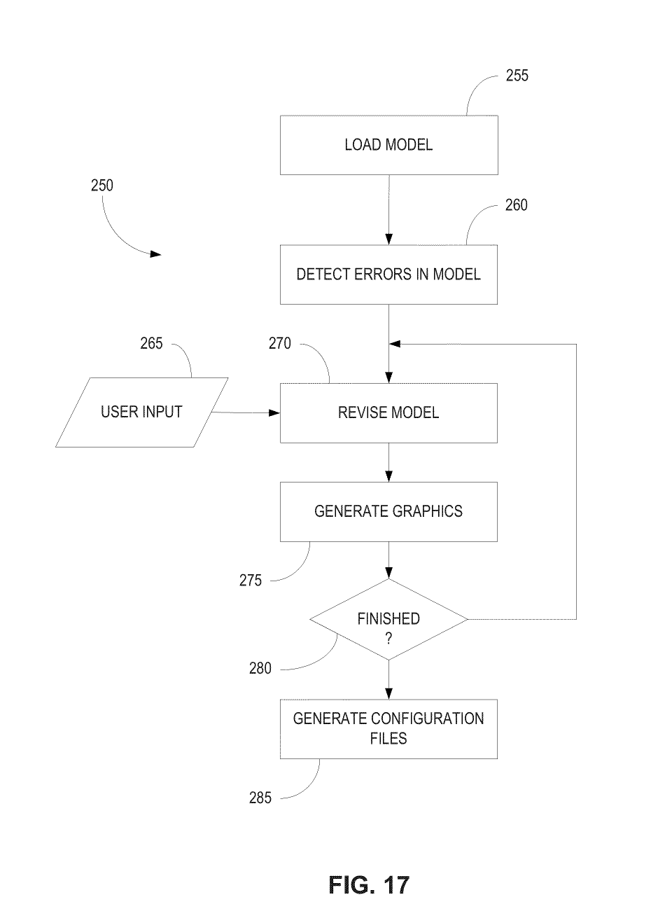

FIG. 17 illustrates an exemplary process 250 for creating a site configuration model using the configuration tool 10. When the configuration tool 10 is launched, the configuration editor 20 loads a site configuration model (block 255). In some embodiments, the configuration editor 20 may be configured to load a default site configuration model. The default site model may be a blank site configuration model. The configuration editor 20 may also be configured to load a site model from a selected pre-existing configuration file. In this case, the configuration editor 20 may include an error module 22 (FIG. 1) that detects semantic and syntactical errors in the loaded configuration file (block 260). Once the site configuration model is loaded, the configuration editor 20 may receive user input via a graphical user interface as shown in FIGS. 9-13 (block 265). Based on the user input, the configuration editor 20 revises the site configuration model (block 270). When the site configuration model is revised, the configuration editor 20 notifies the configuration graphics generator 30, which then creates a graphical representation of the new site configuration model (block 275). The graphics are generated in real-time so that the user can immediately see the changes made in the site configuration model. The revision of the site configuration model and graphics generation process continues in an iterative fashion until the user is finished (block 280). When the user is finished, the configuration file generator 25 creates, for example, a XML document based on the final site configuration model (block 285). The site configuration model and configuration file may be saved in memory 110.

The configuration tool 10 enables the creation with a single tool of a site-wide equipment and carrier configuration for a mixed mode network site implementing multiple communication standards and RATs. The graphical user interface and business logic of the configuration editor 20 requires minimal training, enforces consistency, and avoids data fill errors. Graphics representing the entire site configuration can be generated in real time allowing the user to visualize the site configuration as it is being created. Configuration files may be generated for use with other network planning tools. The ability to load existing configuration files allows variants of a basic configuration to be quickly generated and supports effective troubleshooting. The configuration tools also enables detection of non-standard site configuration when an existing configuration file is loaded and may be used for site configuration auditing.

What is claimed is:

1. A computer system for generating a site configuration for a network site in a mobile communication network, the computer system comprising:
an editing circuit configured to:
receive user input of configuration data; and
generate, based on the user input, a mixed-mode site configuration model comprising a collection of data objects representing two or more nodes implementing different communication standards;
a graphics generating circuit configured to create an integrated digital graphical representation of the mixed mode site configuration model for display to a user on an electronic display device; and
a file generating circuit to create a digital configuration file for said two or more nodes from the mixed mode site configuration model.

2. The computer system according to claim 1 wherein the editing circuit is further configured to load a pre-existing site configuration model from a configuration file; and to modify the pre-existing site configuration model to create a new site configuration model.

3. The computer system according to claim 2 wherein the editing circuit is further configured to detect semantic and syntactical errors in the pre-existing site configuration model.

4. The computer system according to claim 1 wherein the editing circuit is further configured to load a template for a predefined site configuration model; and to modify the predefined site configuration model to create a custom site configuration model.

5. The computer system according to claim 1 wherein the editing circuit is further configured to detect consistency errors in the mixed-mode site configuration model.

6. The computer system according to claim 1 wherein the editing circuit is configured to receive user input via a graphical user interface that includes one or more control elements to receive the user input.

7. The computer system according to claim 6 wherein the editing circuit is further configured to enforce consistency in the site configuration model by applying a predefined set of rules to the control elements in the graphical user interface.

8. The computer system according to claim 7 wherein the editing circuit is configured to enforce consistency by displaying settings for a lower order control element that are compatible with settings for a higher order control element.

9. The computer system according to claim 7 wherein the editing circuit is configured to enforce consistency by modifying a setting for a lower order control element when a setting for a higher order control element is modified.

10. A method implemented by a computer system of generating a site configuration for a network site in a mobile communication network, the computer system including an editing circuit, a graphics generating circuit, and a file generation circuit, the method comprising:
receiving, by the editing circuit, user input of configuration data; and
generating, by the editing circuit based on the user input, a mixed-mode site configuration model comprising a collection of data objects representing two or more nodes implementing different communication standards;
creating, by a graphics generating circuit, an integrated digital graphical representation of the mixed mode site configuration model for display to a user on an electronic display device; and
generating, by a file generating circuit, a digital configuration file for said two or more nodes from the mixed mode site configuration model.

11. The method according to claim 10 further comprising:
loading, by the editing circuit, a pre-existing site configuration model from a configuration file; and
modifying, by the editing circuit, the pre-existing site configuration model based on the user input to create a new site configuration model.

12. The method according to claim 11 further comprising detecting semantic and syntactical errors in the pre-existing site configuration model.

13. The method according to claim 1 further comprising:
loading, by the editing circuit, a template for a predefined site configuration model; and
modifying, by the editing circuit, the predefined site configuration model to create a custom site configuration model.

14. The method according to claim 1 further comprising detecting, by the editing circuit, consistency errors in the mixed-mode site configuration model.

15. The method according to claim 1 wherein receiving user input of configuration data comprises receiving user input via a graphical user interface that includes one or more control elements to receive the user input.

16. The method according to claim 15 further comprising enforcing, by the editing circuit, consistency in the site configuration model by applying a predefined set of rules to the control elements in the graphical user interface.

17. The method according to claim 16 wherein enforcing consistency in the site configuration model comprises displaying settings for a lower order control element that are compatible with settings for a higher order control element.

18. The method according to claim 16 wherein enforcing consistency in the site configuration model comprises modifying a setting for a lower order control element when a setting for a higher order control element is modified.
